(19) United States
(12) Patent Application Publication
(10) Pub. No.: US 2008/0044618 A1
(43) Pub. Date: Feb. 21, 2008

(54) Method and Apparatus for Coating a Substrate and Printed Matter

(75) Inventor: Vilho Nissinen, Numminen (FI)

Correspondence Address: STIENNON & STIENNON, 612 W. MAIN ST., SUITE 201, P.O. BOX 1667, MADISON, WI, 53701-1667, US

(73) Assignee: METSO PAPER, INC., Helsinki (FI)

(21) Appl. No.: 11/571,448

(22) PCT Filed: Jul. 1, 2005
(86) PCT No.: PCT/FI05/00307

§ 371 Date: Jan. 10, 2007

(30) Foreign Application Priority Data
Jul. 2, 2004 (FI) 20040933

(51) Int. Cl. B05C 9/00; B05D 3/00; B32B 5/00

(52) U.S. Cl. 428/77; 118/46; 427/355

(57) ABSTRACT

A method and an apparatus for coating a substrate (7), in which a coating agent (9) is applied onto the substrate (7) in order to form a printing surface, and in which the coating agent (9) is brought into contact with the substrate (7) with a solids content above 80%, and the coating agent (9) is fixed to the substrate (7), the coating being performed during a printing process in a printing machine (10), between the input of the substrate (10) and the output of the printed matter (1), before the actual information (2, 3, 4) is printed.

### CROSS REFERENCES TO RELATED APPLICATIONS

This application is a U.S. national stage application of international app. No. PCT/FI2005/000307, filed Jul. 1, 2005, the disclosure of which is incorporated by reference herein, and claims priority on Finnish App. No. 20040933, filed Jul. 2, 2004, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to a method for coating a substrate, in which a coating agent is applied to the substrate in order to form a printing surface and in which the coating agent is brought into contact with the substrate with a solids content above 80% and the coating agent is fixed to the substrate.

The invention also relates to an apparatus for coating a substrate, comprising a device for applying a coating agent with a solids content above 80% on the substrate in order to form a printing surface and a device for fixing the coating agent to the substrate.

The invention also relates to a printed matter comprising printed information in the form of images and text and in which the image information accounts for a considerable proportion of the surface area of the entire printed substrate, i.e. 10-90%, the printed matter containing at least a substrate, a coating layer containing a substantial content of calcium carbonate CaCO₃ and at least one layer of printing ink.

In connection with this invention, substrate denotes a paper, board or other fiber web, which may also be divided into sheets. The grammage of the paper web is typically of the order of 25 to 150 g/m² and that of the board web has a value above this. Paper grades having low grammage include e.g. various list papers, paper grades with average grammage include e.g. ordinary copying paper, of the order of 80 g/m², and heavy paper grades include e.g. various art papers. In the case of board, the purpose of use determines the required thickness and the grammage, a very typical grammage being 240 g/m² regarding packaging board.

In connection with this invention, a printing surface implies a substrate coated with a coating agent. Picture information in the context of this invention denotes photographs and derivatives of these, graphs, signs or drawings, etc. accentuated text differentiated from the remaining text and similar conspicuous passages. Text information in the context of this invention implies other printed information, such as ordinary text, lines, square patterns and similar patterns, which are usually printed in one single color or without dark or color shades. A printing substrate in the context of this invention implies generally a surface on which general information such as a text can be printed and which can be uncoated or coated.

Printing surfaces have conventionally been produced by coating a substrate, i.e. a paper or board web, with a coating agent, i.e. a coating paste, in a coating machine. This coating process has been performed either in connection with the paper-making machine, as an on-line process, or as a separate off-line process. In an on-line process, the continuous web having been formed in the paper-making machine runs directly to the coating machine, and the web is wound only after the coating process steps. In off-line coating, the web is wound after the paper-making machine and this web is coated in a separate coating machine by seaming a new roll after each web unwound from the preceding roll. There is a range of different options available for the coating proper: blade coaters, size press coaters, spray coaters, curtain coaters, etc. The common feature for all these coaters is application of an aqueous coating paste over the entire width of the dry web, followed by drying of the coating paste and the partly wetted web by means of driers, such as infrared radiators, blow driers or cylinder driers. The coating paste typically has a solids content of the order of 40 to 60%. Typical solids include e.g. kaolin and calcium carbonate. By repeating the coating process a sufficient number of times, one achieves on principle a printing surface which reproduces printed images excellently. Such a combination may comprise e.g. coating of both sides of the web, first with a size press coater and subsequently coating of both sides with a blade coater. In the practice, this means that the web is wetted and dried four times. Coating is usually followed by calendering in order to achieve a printing surface having adequate gloss and smoothness. Then the web is formed as a “machine roll”, which, in turn, is divided in a winder into rolls with smaller width and web length adapted to a printing machine.

The process for producing a printing surface described above is unstable. In terms of the efficiency of the production process, it would thus be advantageous for the production to be continued unaltered for as long as possible. In the practice, customers buying printing surface often want products with e.g. varying grammage and coating agent thickness, and this requires a shift of the production process, i.e. a grade change. Such changes of a running parameter cause perturbations that impair the produced quality. The product quality will not be regained until the production process has been operating for a while after the shift. The product produced during such regulation is in most cases recycled, i.e. it is repulped in fibrous form.

WO 02/01001A1 discloses a method for coating at least one side of a paper or board web with a dry treatment agent, which contains a binder capable of changing its state at least at a raised temperature, for treating the web with the treatment agent, and subsequently raising the temperature of these such that the binder gets into a deformable state, and then dropping the temperature again, the binder bonding the treatment agent and the web. The treatment agent is brought to the surface of the web by electric charge and the raised temperature is generated e.g. by means of a heated roll.

WO 03/076719A1 discloses a method in which powderous particles are disposed on a temporary substrate, from where they are detached and transferred to the substrate proper. In a preferred embodiment of this invention, the temporary substrate is an endless belt, from where the powderous particles are detached and transferred to the substrate proper by means of electric forces.

WO 03/076717A1 discloses various optional coating agents for use in dry coating and their treatment methods.

In printing machines, the printing ink is transferred to the printing surface with the purpose to produce a high print quality suitable for the purpose of use. Newspaper print does not require the same high print quality as does printing of picture books and magazines that are intended to be kept for a long time and to be looked at often. As a matter of fact, newspapers show a trend towards more multicolored typography, because this achieves a product that is more attractive both for the reader and for those who buy advertisement space. In various advertising printed matter it is advantageous to use printing techniques producing extremely high printing quality for the advertised product to be reproduced in the printed picture as naturally and attractively as possible. On the other hand, a printed matter signals also other values, it always has a subjective image. Recycled slightly bleached paper is often a sign of an environment-friendly and economical approach, whereas paper that has been recoated many times may in some cases be experienced as a wasteful attitude that cares less for the environment. Such partly subjective issues still matter in terms of how well the message of the printed matter is transmitted to the target public. The properties of the printing surface are very important, and they are crucial in terms of the printing quality. Such properties of the printing surface include e.g. smoothness, gloss, color, opacity, porosity, ink absorption, color reproducibility, surface strength, etc. It is, of course, more difficult to produce printing surfaces for the printing of exactly reproduced photographs or other pictures, or compact surfaces in general, i.e. a continuous covering printing ink layer, than surfaces acting merely as a substrate for a text. In terms of the printing of a text, one of the chief features is controlling ink absorption in order to maintain a neat printing quality and to avoid absorption of the printed text out of control into the substrate, which would produce a messy impression. Nonetheless, most people actually find it more pleasant to read a text on a matt surface than on a glossy surface reproducing the printed pictures in a very natural form. Nowadays there is a multitude of different printing methods, including among other things: gravure, offset, flexo printing, and the current trend of different digital printing methods, such as ink-jet printing.

In most printing methods, color pictures are produced by four-color printing, using three colors to produce them: cyan (bluish green), magenta (bluish red) and yellow, with black as a backing color. By suitable combinations of these, e.g. by changing the halftone dot size and density, an almost unlimited number of different colors is produced. In terms of picture quality, it is of paramount importance to register these halftone dots correctly relative to each other. A printing machine usually prints these different colors successively, with one printing unit producing one single color. Mutual registering of halftone dots is called register printing, and in order to verify successful registering, “register marks” are often printed in the margin of the printed matter, enabling easy detection of successful registering.

### SUMMARY OF THE INVENTION

The purpose of the invention is to achieve a more efficient and economical manner of producing a printing surface, which is capable of reproducing exactly printed information in the form of pictures, and on the other hand, provides an economical printing substrate for printed text information.

The invention also has the purpose of improving the material efficiency of the printing surface so as to provide high printing quality using fewer resources than before: less material and lower energy costs than before. The invention also has the purpose of allowing the production of a printed matter having the suitable image value without having to compromise on the reproduction accuracy and printing quality of picture information during the production of the printed matter. The invention also has the purpose of allowing a situation where the producer of the printing surface or the printed substrate could reduce the number of grades produced and thus possibly prolong the time used for producing one specific grade, i.e. enlarge the production lot, requiring less process control as the grade changes decrease. This enhances the efficiency of the production process since the production loss caused by grade changes is reduced.

The invention also has the purpose of simplifying and reducing the devices needed to achieve a high-quality printing surface and thus of reducing the total investment cost for providing a printing surface. Another objective is reducing the chemicals needed in the papermaking and coating machine and reducing the environmental load caused by these processes.

The method of the invention is characterized by the coating being performed during the printing process in a printing machine, between the input of the substrate and the output of the printed matter, with the coating performed before the actual printing of information. Carried out in this manner, a printing surface is produced with appreciable efficiency and economy, which is capable of reproducing picture information accurately and on the other hand, provides an economical printing substrate for text information.

In a preferred embodiment of the invention, the printing surface is formed at such locations of the substrate alone where picture information is printed. A substrate formed in this manner will not be coated unnecessarily, but only at locations where coating is truly necessary, i.e. under picture information.

In a second preferred embodiment, coating is performed in the same register as at least part of the information to be printed. In other words, at least part of the picture or text information can, if necessary, be printed on an uncoated printing substrate, if desired, and accordingly, part of the text or picture information can be printed on a coated surface allowing high picture quality, i.e. on a printing surface. This allows for easy production of printed matters with varying product images, while still achieving a smart appearance and good reproduction accuracy of picture information.

The device of the invention is characterized by the apparatus being integrated in the same process as the devices for printing information, the apparatus being located in the direction of travel of the substrate before the devices for printing information, the apparatus comprising also a control unit, by means of which the printing surface to be coated and the information to be printed can be registered relative to each other, and means for performing this registering.

In a preferred embodiment, the apparatus comprises means for coating and/or forming selectively a portion of the printing surfaces, the entire printing surface, a portion of the printing substrate, the entire printing substrate, or the entire substrate.

The printed matter of the invention is characterized by the surface area of the coating layer being nearly equal to that of the picture information, the coating layer being registered in parallel with the substrate surface so as to be principally located underneath the printing ink layer used for printing the picture information.

The invention is explained in further detail below with reference to the accompanying drawings.

### BRIEF DESCRIPTION OF THE DRAWINGS

FIG. 1 shows a simplified example of a printed matter produced in accordance with one embodiment of the invention.

FIG. 2 illustrates a principle drawing of the device of the invention.

FIG. 3 is a schematic view of an alternative embodiment device of the invention.

### DESCRIPTION OF THE PREFERRED EMBODIMENTS

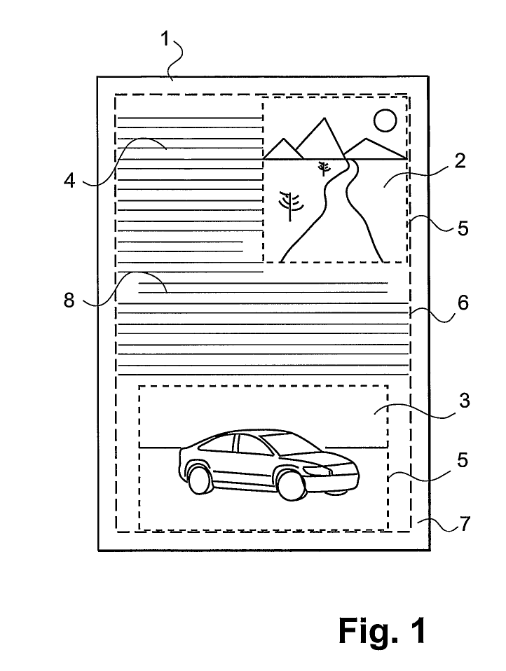

FIG. 1 illustrates a typical page of a printed matter 1, such as a magazine. It comprises printed picture information 2, 3 and printed text information 4. The printing surface 5 has been formed in register with the pictures, i.e. it is provided substantially only at the location of the pictures. The accuracy of this register coating can, it is true, be made slightly less accurate than the accuracy of printing actual pictures, yet the visually smartest outcome is obtained if the coating is performed almost with the same accuracy as the actual printing, and the coated printing surface will not form any margins or frames around the pictures. As a second option, one could leave a printing surface with a format slightly smaller than that of the picture, but in this case as well, the picture quality would be poorer in the border areas than in the center, and the picture would perhaps not look right in visual inspection. These could be very useful means for changing and varying the appearance of a printed matter for effect and style.

If desired, one can naturally coat the entire substrate 7, or at least to the extent it will be used as a printing substrate. In the practice, this option is comparable to conventional coating in a paper or coating machine, while achieving savings in the form of decreased drying and grade shifts.

The printed matter 1 shown in FIG. 1 can be formed e.g. on a slightly bleached substrate 7 containing abundantly of recycled fibers, with its printing substrate 6 coated only at the location of the printing surface 5 that will get underneath the printed picture information. Such an application achieves a surprising contrast with respect to printed picture information 2, 3, especially the resolution and printing quality of the pictures, compared to the general aspect of the printed matter 1, which may give ever so modest an impression, signalling economy, anti-waste and a very environmental-friendly approach. In this case, the printing surface may be formed e.g. of a coating agent layer having a thickness of 6 μm after the coating agent has been fixed and polished by means of a heated roll, and whose main constituents are CaCO₃ and latex. The printing substrate 6 underneath the printed text information 4 can be left uncoated, having thus a somewhat plain look. The printing ink 8 used for printing text information is selected in accordance with the properties of the substrate 7, so that the letters are reproduced neatly and with sharp limits.

In a preferred embodiment, the coating is performed with maximally equal register accuracy as actual picture printing. The halftone dots forming the picture and the coating can hence be registered with high precision relative to each other, thus achieving a printed picture with very sharp limits and high quality.

Other optional embodiments comprise methods, in which the printing substrate on which only text information is printed or which is left unprinted is not coated; or the coating is performed on the surface of the substrate in order to form a printing surface with a width equaling partly or entirely that of the printing substrate or the substrate. With this procedure, the substrate can be coated or not in a freely chosen manner as necessary in each case.

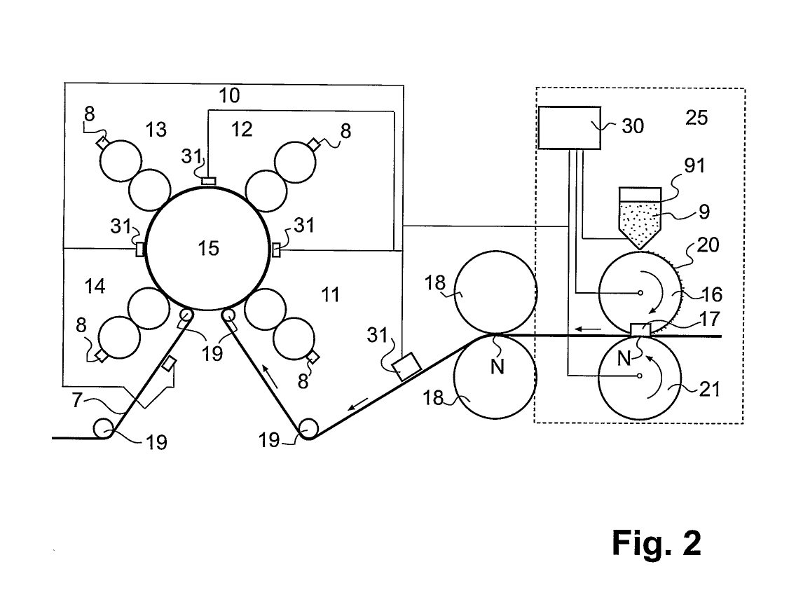

For the purpose of illustration, FIG. 2 shows a part of a printing machine 10 and the apparatus of the invention. The substrate 7 has a web-like shape and its direction of movement is indicated with arrows. First in the direction of movement of the substrate is a device 16 for applying coating agent. The application of coating agent 9 is controlled with a control and regulation system 30, which receives data from detectors 31. The device 17 for fixing coating agent has been illustrated as connected to the same device as the device 16 for applying coating agent. The device 16 for applying coating agent comprises a support base 20, which forms a nip N together with a counter-roll 21. Dry powderous coating agent 9 is contained in a container 91. The device 18 for finishing the coated surface consists of two rolls and a nip N formed between these. The printing machine 10 has four printing units 11, 12, 13, 14, one for each color 8, yellow, cyan, magenta and black. Guide rolls 19 serve to guide the web movement.

As illustrated in FIG. 2, the method of the invention has the following operation. The web-like substrate 7 runs through the printing machine 10 as indicated by the arrow. The substrate 7 is formed as a printing surface 5 by coating with the aid of the coating unit 25 at necessary locations. These necessary locations are particularly locations at which picture information will be printed at a subsequent stage. The device 16 for applying coating agent spreads the dry powderous coating agent 9 onto the substrate. In the practice, the application is carried out in the same manner as printing inks are printed, in other words, the coating agent 9 is first spread over the surface acting as a support substrate 20, from where it is then transferred to the substrate 7. This allows utilization of the chemical and electric properties of the support substrate 20, these properties, in turn, allowing the application of the coating agent 9 exactly in register with the picture to be subsequently printed. In case only the printing surface under the pictures is coated, it is crucial at this stage of the process that the dry coating agent is registered with high precision relative to the surface of the support substrate. This can be carried out in the manner of a printing machine by chemical preparation of the surface of the support substrate 20 which in reality is cylindrical or belt-like and acts as the application device 16, with the coating agent 9 adhering temporarily, before getting into contact with the substrate 7, only to the desired locations of the surface, and at the locations where no coating agent is desired, the surface of the support substrate 20 rejects the coating agent. Such chemical preparation of the support substrate 20 can be performed e.g. in a separate preparation device by means of an appropriate means, such as a solution of the type of an ink-jet printer. If necessary, this preparation device can also be brought into connection with the coating unit 25. These different options have the advantage of the separate device being usable for the preparation of many different support substrates, and on the other hand, the preparation device disposed in the coating unit allows for the formation of a new surface without removing the cylinder or the like of the application device 16. Optionally, application of the coating agent can also be performed using a conventional solution of photocopying type, the so-called Xerox method, which also uses a support substrate for the transfer of the coating agent. In this method, the surface of the support substrate 20 is initially subjected to electrostatic treatment, next the picture of the object to be coated is formed e.g. by projection or by laser on the surface of the support substrate 20, whereby part of the charges are discharged and part are maintained, then the coating agent 9 is spread over the surface of the support substrate 20, to which it adheres only at locations still being charged, then the coating agent and the substrate are pressed through the same nip N, the coating agent pattern being transferred from the support substrate 20 to the surface of the substrate, and finally the adhesion of the coating agent is prepared by heating with the device 17 for fixing the coating agent or with the device 18 for finishing the coated surface. A method of ion blast type can also be used for transferring the coating agent to the support substrate, this being potentially a very advantageous method if one wishes to coat the entire surface of the substrate 7.

A second option is generating an electric modification directly in the surface of the substrate, allowing the coating agent to be registered at the correct location of the substrate. This method is slightly more difficult to carry out than the first one, because the adhesion properties depend to a large extent on the properties of the substrate, and the substrate, in turn, varies in accordance with the printing house's customers, in other words, it is somewhat more difficult to provide a standard process than in the embodiment using a support substrate as explained above.

After the coating agent has been applied, the coating agent is fixed by means of the device 17 for fixing the coating agent. FIG. 2 illustrates the device 17 for fixing the coating agent connected to the same device as the device for applying the coating agent, in other words, the coating agent is fixed to the substrate 7 under the pressure of the nip formed by the heated roll acting as a support substrate 20 and its counter-roll 21. Generally speaking, the coating agent is fixed to the substrate by heat, the heat being generated e.g. by contact with a heated cylinder, without contact by radiation heat, or by any other heat-generating method, the heat being usable for acting on other properties of the printing surface than the fixing of the coating agent to the substrate.

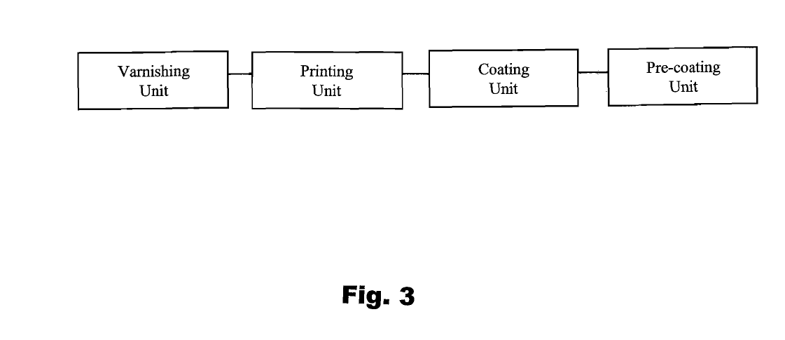

After the device 16, 17 for applying and fixing the coating agent, a device for finishing the coated surface is shown in the direction of movement of the web, this device being here illustrated also as a pair of rolls forming a nip. When passing through the nip, the printing surface is slightly deformed under heat and pressure, which in the practice means that the printing surface is slightly calendered and the smoothness of the printed surface increases. This is followed by the actual printing step. The web runs along the surface of the cylinder 15 and each printing unit 11, 12, 13, 14 prints its specific printing ink 8 on the printing surface or the printing substrate. The registering of the printing units is preferably monitored by detectors 31, and if necessary, a control and regulation system 30 carries out rectifying control operations e.g. by a momentary change of the rotation speed of the rolls or by modifying the axial position. In an optional embodiment, the detectors 31 may e.g. monitor the register marks at a sampling frequency corresponding to the rotation of the printing rolls, allowing visual inspection of the register mark. The following step may comprise coating by providing a glossy surface on the pictures, if desired, such gloss not only enhancing the picture quality, but also protecting the pictures from drying. This is preferably performed by means of varnish or any other clear transparent coating agent, as shown in FIG. 3, or any other known means for achieving a glossy surface.

Coating can, of course, be applied to one or both sides of the substrate. The coating units 25 can be disposed in succession or in the same unit, as necessary in each case, with both sides of the substrate being coated in the same operation. If necessary, these operations can be combined, with one step comprising coating as a kind of pre-coating on the entire substrate, as shown in FIG. 3, and the second step comprising coating in register with the pictures to be printed. If desired, this can be carried out with coating units of a slightly different type, e.g. pre-coating with a procedure based on the transfer of charged particles of ion-blast type, and register coating using a registering method of laser type.

To achieve a successful result, the materials to be used should be selected with their glass transition temperatures Tgx in appropriate mutual relationship. When the substrate 7 is treated with the coating agent 9 and the coating agent is fixed by heat to the substrate 7, the glass transition temperature Tgc of the coating agent 9 should be lower than the glass transition temperature Tgs of the substrate 7, in order to achieve good adhesion and the desired effect of the heat. Accordingly, the glass transition temperature Tgp of the printing inks 8 should be lower than that of the coating agent 9. In other words, the temperatures follow the equation Tgp<Tgc<Tgs. Selected in this manner, the heat will always have the desired effect on the correct layer, without deteriorating the lower layer. The particle size of the coating agent used is also preferably smaller than pore size of the substrate, resulting in a printing surface smoother than the substrate.

Reference numerals used in the figures:
1 printed matter
2 printed picture information
3 printed picture information
4 printed text information
5 printing surface
6 printing substrate
7 substrate
8 printing ink
9 coating agent
91 reservoir
10 printing machine
11 printing unit, yellow
12 printing unit, cyan
13 printing unit, magenta
14 printing unit, black
15 cylinder
16 device for applying coatinc
17 device for fixing coating agent
18 device for finishing coated surface
19 guide roll
20 support substrate
21 counter-roll
25 coating unit
30 control and regulation system
31 detector
N nip

1-17. (canceled)

18. A method of printing on a fiber substrate comprising the steps of:
supplying an uncoated fiber substrate to a printing machine;
moving the web through a coating unit in the printing machine and coating at least selected portions of the uncoated substrate with a coating agent with a solids content above 80% in the coating unit;
fixing the coating agent to the substrate in the coating unit, to form a coated portion within the printing machine; and
following the coating unit, printing information with a printing unit on at least the coated portions within the printing machine.

19. The method of claim 18 wherein the fiber substrate has a selected glass transition temperature, and the coating agent has a glass transition temperature of less than the glass transition temperature of the fiber substrate, and further comprising the step of fixing the coating agent to the substrate by fusing the coating agent to the fiber substrate at a temperature high enough to achieve adhesion and less than the fiber substrate glass transition temperature.

20. The method of claim 19 further comprising the step of finishing the coated portions of the substrate by passing the substrate through a nip which applies heat and pressure and increases the smoothness of the coated portions.

21. The method of claim 18 wherein the step of coating portions of the uncoated substrate with the coating agent produces a coating whose main constituents are CaCO₃ and latex.

22. The method of claim 20 wherein the step of coating portions of the uncoated substrate results in the coating having a thickness of 6 μm after the substrate pass through the nip.

23. The method of claim 18 wherein the coated portions are arranged in register with at least selected portions of the printed information.

24. The method of claim 21 further comprising the step of creating a printed document wherein coating is applied only to the selected portions of the uncoated substrate, thereby constructing a printed sheet on which portions of the document are printed on coated paper, and portions are printed on non-coated paper.

25. The method of claim 19 further comprising four successive printing steps printing one printing ink on said coated portions, using four printing units one for each successive printing step, wherein each of said four printing units prints an ink having a glass transition temperature lower than the glass transition temperature of the coating, and fixes the ink to the substrate by adhering the ink to said coated portions at a temperature high enough to achieve adhesion and lower than the glass transition temperature of the coating.

26. The method of claim 20 further comprising coating only portions of the substrate.

27. The method of claim 20 further comprising coating the entire substrate.

28. The method of claim 18 wherein the substrate moves as a continuous web from the coating unit to the printing unit.

29. The method of claim 19 wherein the coating agent is fixed to the substrate by heat generated by contact with a heated cylinder.

30. The method of claim 18 wherein the fiber substrate has pores of a selected size, and wherein the coating agent is composed of particles having a particle size smaller than the pore size of the substrate, so that when the coating agent is fused to the substrate a printing surface which is smoother than the substrate results.

31. The method of claim 18 further comprising precoating the entire substrate with a precoating in a precoating unit before coating only the selected portions of the substrate in the coating unit.

32. The method of claim 18 wherein the substrate has two sides, and further comprising coating both sides of the substrate.

33. The method of claim 24 further comprising applying a clear transparent coating agent to said coated portions after printing on said coated portions.

34. The method of claim 18 wherein coating agent is dosed onto a moving base, from where the coating agent is transferred to the substrate.

35. A printing machine comprising:
a fiber substrate;
a coating unit having a coating reservoir filled with a coating agent having a solids content above 80%;
within the coating unit a means for applying the coating agent to selected portions of the fiber substrate, and a means for fixing the coating agent on the selected portions of the substrate to form a coating on said portions of the substrate;
a printing unit in substrate receiving relation to the coating unit; and
a control unit in controlling relation to the coating unit and the printing unit such that printing performed in the printing unit is mutually registered with said selected regions of coating applied in the coating unit by means for performing mutual registration.

36. The printing machine of claim 35 wherein the fiber substrate has a glass transition temperature, and wherein the coating agent has a glass transition temperature less than the fiber substrate glass transition temperature, and wherein the means for fixing the coating agent on the selected portions of the fiber substrate includes means for heating the coating agent to a temperature high enough to achieve adhesion to the fiber substrate and less than the fiber substrate glass transition temperature.

37. The printing machine of claim 35 wherein the means for applying the coating agent to selected portions is a means for coating the entire fiber substrate.

38. The printing machine of claim 35 further comprising devices for finishing a coated and printed surface of the fiber substrate with a transparent layer after the printing unit and in substrate receiving relation to the printing unit.

39. A printed matter comprising:
a fiber substrate having a surface and a surface area;
printed picture information forming an ink layer accounting for a first area of 10-90% of the surface area of the fiber substrate;
a coating layer having a substantial calcium carbonate CaCO₃ concentration, the coating layer being on the fiber substrate and covering a coated area nearly equal to the first area;
wherein the coating layer is registered in parallel on the surface of the substrate such that the coating layer lies mainly underneath the printed picture information forming the ink layer.

40. A method of printing on a continuous paper or board web having a surface and a surface area and a web glass transition temperature, the method comprising the steps of:
supplying a continuous uncoated paper or board web to a printing machine;
moving the continuous web through a coating unit and coating therein at least 10-90% of the uncoated web with a coating agent having a coating glass transition temperature less than the web glass transition temperature, and a solids content above 80%, the coating agent having main constituents which are CaCO₃ and latex to thus form coated portions;
fixing the coating agent to the web in the coating unit by fusing the coating agent to the paper or board web at a temperature high enough to achieve adhesion and less than the web glass transition temperature to form the coated portion within the printing machine;
after the coating unit finishing the coated portions of the web by passing the web through a nip which applies heat and pressure and increases the smoothness of the coated portions; and
following the coating unit and after finishing the coated portions, printing printed picture information forming a ink layer in register with the coated portions, with four successive printing steps, printing one printing ink having a glass transition temperature less than the coating glass transition temperature on said coated portions in each of the four successive printing steps, using four printing units, one for each successive printing step, wherein each of said four printing units prints and fixes the ink to the web by adhering the ink to said coated portions at a temperature high enough to achieve adhesion.
